(19) United States
(12) Patent Application Publication
(10) Pub. No.: US 2023/0326265 A1
(43) Pub. Date: Oct. 12, 2023

(54) METHODS AND SYSTEMS FOR MULTI-CORE PROCESSOR MANAGEMENT

(71) Applicant: NIO Technology (Anhui) Co., Ltd., Hefei City (CN)

(72) Inventor: Nathan H. Law, San Jose, CA (US)

(73) Assignee: NIO Technology (Anhui) Co., Ltd., Hefei City (CN)

(21) Appl. No.: 17/716,375

(22) Filed: Apr. 8, 2022

(51) Int. Cl. G07C 5/08; G07C 5/00; G06F 9/48; G06F 9/38

(52) U.S. Cl. CPC G07C 5/0816; G06F 9/3877; G06F 9/4881; G07C 5/008

(57) ABSTRACT

Systems and methods of detecting the occurrence of errors on a multi-core processor are disclosed. Systems and methods include collecting data associated with a first core of a plurality of cores of the multi-core processor with an application executing on a second core of the plurality of cores, detecting, with the application executing on the second core of the plurality of cores, an occurrence of an event associated with the first core of the plurality of cores, and generating, with the application executing on the second core of the plurality of cores, a report comprising information associated with the event associated with the first core of the plurality of cores.

### FIELD

The present disclosure relates generally to multi-core processors and more particularly toward methods and systems of monitoring and responding to events occurring on a core of a multi-core processor.

### BACKGROUND

Modern vehicles include a number of computing devices operating as vehicle control systems. Vehicle control systems include one or more processors which run firmware, processes, and applications to control one or more components of a vehicle. During operation, processors of vehicle control systems are prone to errors due to a variety of issues, such as runtime errors, cyberattacks, etc.

An error in a processor of a vehicle controller can cause vehicle problems which may render a vehicle incapable of driving. Vehicle problems arising due to problems with vehicle control systems can require a vehicle to be driven or towed to a repair destination to resolve the error.

In some cases, a vehicle controller must physically be removed from the vehicle and sent to a specific repair destination separate from the vehicle, further delaying the operability of the vehicle and increasing the cost of repair. Furthermore, many issues arising in conventional vehicle controllers are errors occurring in relation to a processor, such as firmware issues or application errors. By the time the vehicle and/or vehicle controller reaches a repair destination, the error cannot be identified due to losses in memory.

Conventional vehicle controllers require a customer service to remove and replace board from vehicle and send the vehicle board back to company. Customer support often lacks needed tools at the field to troubleshoot and analyze a problem. In addition, many of the rare crash issue is not reproducible in house even with customer's vehicle board. In many cases, it is extremely difficult to debug a post-mortem problem if context is not collected at time of crash.

In a conventional vehicle controller, there is no capability outside a controller to health detect error inside a running core nor to early detect a potential failure of a running core. For example, a processor run-time sluggishness and partial thread deadlock are almost impossible to detect from outside a controller. Detecting such errors relies on an external watchdog to reboot system after a core processor fails and system enters a complete halt state. The systems and methods described herein resolve these issues.

### BRIEF DESCRIPTION OF THE DRAWINGS

FIG. 1 shows a vehicle in accordance with embodiments of the present disclosure;

FIG. 2 shows a plan view of the vehicle in accordance with at least some embodiments of the present disclosure;

FIG. 3A is a block diagram of an embodiment of a communication environment of the vehicle in accordance with embodiments of the present disclosure;

FIG. 3B is a block diagram of an embodiment of interior sensors within the vehicle in accordance with embodiments of the present disclosure;

FIG. 4 shows an embodiment of the instrument panel of the vehicle according to one embodiment of the present disclosure;

FIG. 5 is a block diagram of an embodiment of a communications subsystem of the vehicle;

FIG. 6 is a block diagram of a computing environment associated with the embodiments presented herein;

FIG. 7 is a block diagram of a computing device associated with one or more components described herein;

FIG. 8 is a block diagram of a computing device associated with one or more components described herein; and

FIG. 9 is a flowchart illustrating a method in accordance with one or more of the embodiments described herein.

### DESCRIPTION

Embodiments of the present disclosure will be described in connection with a vehicle, and in some embodiments, an electric vehicle, rechargeable electric vehicle, and/or hybrid-electric vehicle and associated systems.

What is needed is a system capable of identifying and resolving issues occurring in a processor of a vehicle control system.

As described herein, a monitor system executed by a core of a multi-core processor of a vehicle control system may be capable of detecting issues occurring in another core of the multi-core processor and responding to the issues by performing functions to resolve the issues and/or generating and transmitting reports relating to the issues to an external system.

In some embodiments, the monitor system may be configured to identify problematic processes, potential cyber-attacks, and other issues, save data relating to the issues, and use the data to build a report relating to the issues.

The systems and methods described herein include a monitor application configured to run on a designated core of a multi-core processor, which may be referred to herein as a monitor core, in a vehicle ECU. Such a system provides certain benefits by implementing a monitor system on a designated core. For example, while conventional vehicle control systems are relatively simple devices, modern processors are generally multi-core. Conventional vehicle control systems use multi-core processors but do not utilize more than a single processor. Therefore, conventional vehicle control systems fail to fully take advantage of the multi-core nature of the processors.

Using a system or method as described herein, the second core of the multi-core processor may be utilized to provide a capability of detecting health issues, debug the issues, provide reporting over the network, etc. By having the monitor application executing on a designated core, any failure occurring on another core may not propagate to the core designated for monitoring, thus improving the likelihood the monitor application may continue operating and be capable of resolving the failure.

Because the health monitor operates on a core of the processor as the core being monitored, the health monitor has more access than an external monitor application, such as register, cache, memory footprint, etc., data. Also, the health monitor may have the power to kill and restart applications and tasks. The health monitor may be configured to collect specific information, such as any data relating to a particular problematic task which may reduce the data bandwidth of a report following a problematic task or a crash report.

Because a health monitor application as descried herein leverages previously unused hardware, i.e., an unused core of a multi-core processor, the application may be installed in vehicle control systems at little to no cost. A health monitor application as described herein provides a variety of functions which avoid the costs and time of users of vehicles having to bring their vehicles into service, not being able to use their vehicles, etc., as described herein.

By using a method 900 of utilizing a core of a multi-core processor to send heartbeats to one or more other cores of the multi-core processor, as described herein, a number of functions may be enabled. For example, through a process of sending heartbeats, the multicore-processor may be configured to detect an error or signs of a future fail state. In the case of detecting a potential failure prior to the failure occurring, the multicore processor may be enabled to proactively take action to prevent failure by identifying and killing culprit tasks and restarting them immediately. In this way, a monitor application executed on a designated core of a multicore processor may be enabled to operate as an error recovery facilitator. When a primary core fails or is about fail, the monitor core may be capable of detecting a failure through heartbeat or through early failure detection mechanism.

Similarly, a monitor core may be capable of debugging a system crash by saving any relevant data which may be assessed, by the monitor core or an application executing on another core or by a third-party application such as one executing on a server. Because the monitor core has access to register, memory footprint, and cache footprint, of the primary core, the monitor core can see the pattern of the code being executed on the primary core.

When a primary core crashes, a program counter of the primary core may jump to an exception. The monitor may be configured to detect the program counter is stuck pointing at an exception. In response, the monitor application may be configured to capture as much data (registers, cache, memory) as possible.

After capturing data in response to an exception, the monitor application may be configured to attempt to recover the primary core—or other core or an application of which the heartbeat targeted. For example, the monitor application may attempt to perform a recovery by clean internal memory and cache and setting the program counter back to a non-exception point.

If the monitor application detects a delay in receipt of a response to the heartbeat signal, the monitor core may begin a process of detecting culprit applications or tasks in order to then end the culprit tasks or restart the system.

As described herein, a monitor core of a multicore processor may be capable of facilitating another core of the processor to speedily recover from a failure through an early failure detection mechanism and/or proactively take action to prevent failure before an error escalated to complete failure.

The systems and methods described herein of using a monitor core application may enable a vehicle control system to function despite events which would render conventional vehicle control systems nonfunctional. As a result, vehicles may continue to run where conventional vehicles would be forced to be towed into a repair center for service.

While throughout the description, certain core numbers are used (e.g., first core, second core, last core, etc.), it should be appreciated the monitoring systems may be implemented on any core of a multi-core processor and the firmware and other applications may also be implemented on any core. For example, the monitor system may be executed by a first core while the system firmware may be executed by a second core. Also, certain aspects of the monitor system may be executed by a plurality of cores. Likewise, the system firmware may be executed by a plurality of cores. The embodiments described herein should not be considered as being limited in any way to being performed by any particular core or cores or any single core.

The following detailed description refers to the accompanying drawings. The same reference numbers in different drawings may identify the same or similar elements.

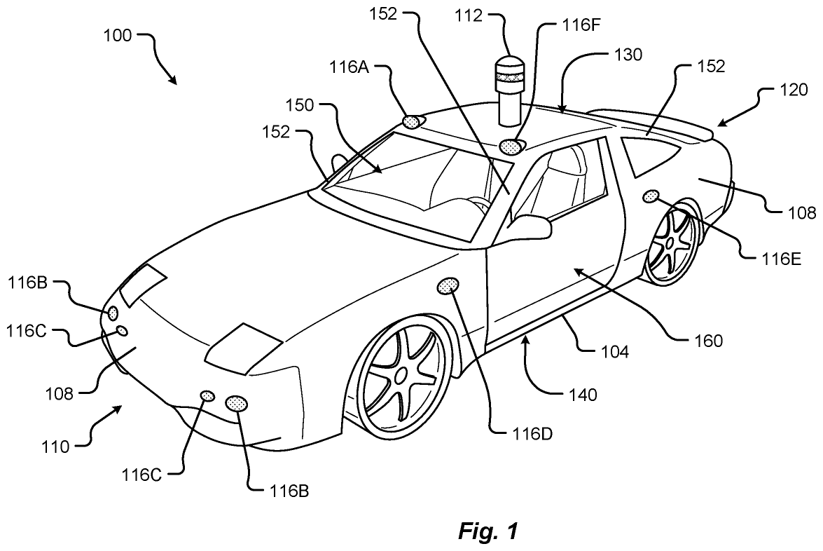

FIG. 1 shows a perspective view of a vehicle 100 in accordance with embodiments of the present disclosure. The electric vehicle 100 comprises a vehicle front 110, vehicle aft or rear 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

In some embodiments, the vehicle 100 may include a number of sensors, devices, and/or systems that are capable of assisting in driving operations, e.g., autonomous, or semi-autonomous control. Examples of the various sensors and systems may include, but are in no way limited to, one or more of cameras (e.g., independent, stereo, combined image, etc.), infrared (IR) sensors, radio frequency (RF) sensors, ultrasonic sensors (e.g., transducers, transceivers, etc.), radio detection and ranging (RADAR) sensors (e.g., object-detection sensors and/or systems), light detection and ranging (LiDAR) sensors and/or systems, odometry sensors and/or devices (e.g., encoders, etc.), orientation sensors (e.g., accelerometers, gyroscopes, magnetometer, etc.), navigation sensors and systems (e.g., GPS, etc.), and other ranging, imaging, and/or object-detecting sensors. The sensors may be disposed in an interior space 150 of the vehicle 100 and/or on an outside of the vehicle 100. In some embodiments, the sensors and systems may be disposed in one or more portions of a vehicle 100 (e.g., the frame 104, a body panel, a compartment, etc.). The sensors may include one or more fisheye or other wide-angle cameras which may be placed on an exterior of the vehicle 100 and configured to capture image data exterior to the vehicle 100.

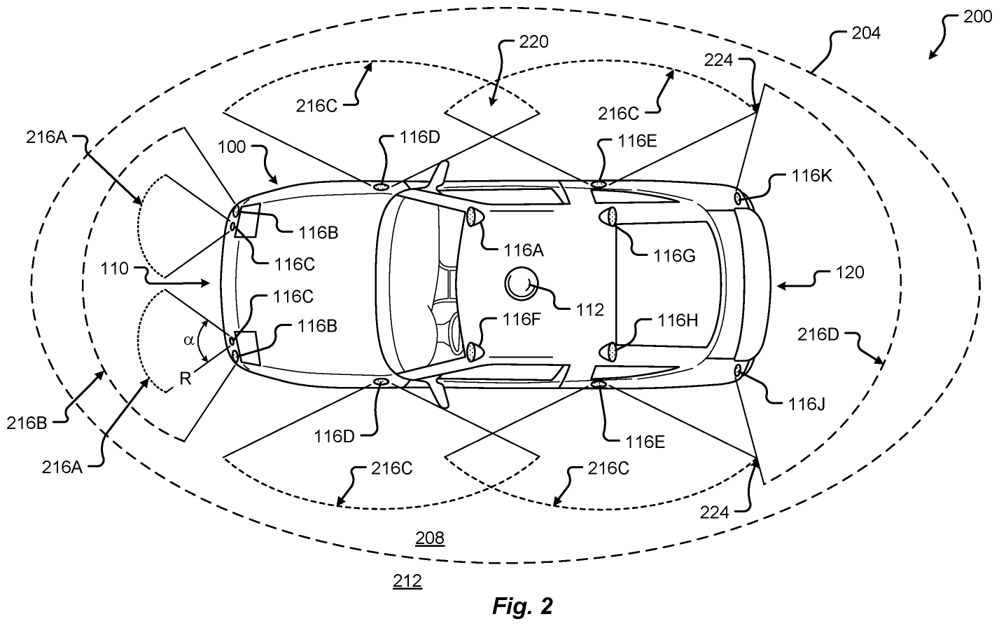

As shown in FIG. 1, the vehicle 100 may, for example, include at least one of a ranging and imaging system 112 (e.g., LiDAR, etc.), an imaging sensor 116A, 116F (e.g., camera, IR, etc.), a radio object-detection and ranging system sensors 116B (e.g., RADAR, RF, etc.), ultrasonic sensors 116C, and/or other object-detection sensors 116D, 116E. In some embodiments, the LiDAR system 112 and/or sensors may be mounted on a roof 130 of the vehicle 100. In one embodiment, sensors may be disposed at least at a front 110, aft 120, or side 160 of the vehicle 100. 0. While shown associated with one or more areas of a vehicle 100, it should be appreciated that any of the sensors and systems 116A-K, 112 illustrated in FIGS. 1 and 2 may be disposed in, on, and/or about the vehicle 100 in any position, area, and/or zone of the vehicle 100.

Referring now to FIG. 2, a plan view of a vehicle 100 will be described in accordance with embodiments of the present disclosure. In particular, FIG. 2 shows a vehicle sensing environment 200 at least partially defined by the sensors and systems 116A-K, 112 disposed in, on, and/or about the vehicle 100. Each sensor 116A-K may include an operational detection range R and operational detection angle. The operational detection range R may define the effective detection limit, or distance, of the sensor 116A-K. In some cases, this effective detection limit may be defined as a distance from a portion of the sensor 116A-K (e.g., a lens, sensing surface, etc.) to a point in space offset from the sensor 116A-K. The effective detection limit may define a distance, beyond which, the sensing capabilities of the sensor 116A-K deteriorate, fail to work, or are unreliable. In some embodiments, the effective detection limit may define a distance, within which, the sensing capabilities of the sensor 116A-K are able to provide accurate and/or reliable detection information. The operational detection angle may define at least one angle of a span, or between horizontal and/or vertical limits, of a sensor 116A-K. As can be appreciated, the operational detection limit and the operational detection angle of a sensor 116A-K together may define the effective detection zone 216A-D (e.g., the effective detection area, and/or volume, etc.) of a sensor 116A-K.

In some embodiments, the vehicle 100 may include a ranging and imaging system 112 such as LiDAR, or the like. The ranging and imaging system 112 may be configured to detect visual information in an environment surrounding the vehicle 100. The visual information detected in the environment surrounding the ranging and imaging system 112 may be processed (e.g., via one or more sensor and/or system processors, etc.) to generate a complete 360-degree view of an environment 200 around the vehicle. The ranging and imaging system 112 may be configured to generate changing 360-degree views of the environment 200 in real-time, for instance, as the vehicle 100 drives. In some cases, the ranging and imaging system 112 may have an effective detection limit 204 that is some distance from the center of the vehicle 100 outward over 360 degrees. The effective detection limit 204 of the ranging and imaging system 112 defines a view zone 208 (e.g., an area and/or volume, etc.) surrounding the vehicle 100. Any object falling outside of the view zone 208 is in the undetected zone 212 and would not be detected by the ranging and imaging system 112 of the vehicle 100.

Sensor data and information may be collected by one or more sensors or systems 116A-K, 112 of the vehicle 100 monitoring the vehicle sensing environment 200. This information may be processed (e.g., via a processor, computer-vision system, etc.) to determine targets (e.g., objects, signs, people, markings, roadways, conditions, etc.) inside one or more detection zones 208, 216A-D associated with the vehicle sensing environment 200. In some cases, information from multiple sensors 116A-K may be processed to form composite sensor detection information. For example, a first sensor 116A and a second sensor 116F may correspond to a first camera 116A and a second camera 116F aimed in a forward traveling direction of the vehicle 100. In this example, images collected by the cameras 116A, 116F may be combined to form stereo image information. This composite information may increase the capabilities of a single sensor in the one or more sensors 116A-K by, for example, adding the ability to determine depth associated with targets in the one or more detection zones 208, 216A-D. Similar image data may be collected by rear view cameras (e.g., sensors 116G, 116H) aimed in a rearward traveling direction vehicle 100.

In some embodiments, multiple sensors 116A-K may be effectively joined to increase a sensing zone and provide increased sensing coverage. For instance, multiple RADAR sensors 116B disposed on the front 110 of the vehicle may be joined to provide a zone 216B of coverage that spans across an entirety of the front 110 of the vehicle. In some cases, the multiple RADAR sensors 116B may cover a detection zone 216B that includes one or more other sensor detection zones 216A. These overlapping detection zones may provide redundant sensing, enhanced sensing, and/or provide greater detail in sensing within a particular portion (e.g., zone 216A) of a larger zone (e.g., zone 216B). Additionally, or alternatively, the sensors 116A-K of the vehicle 100 may be arranged to create a complete coverage, via one or more sensing zones 208, 216A-D around the vehicle 100. In some areas, the sensing zones 216C of two or more sensors 116D, 116E may intersect at an overlap zone 220. In some areas, the angle and/or detection limit of two or more sensing zones 216C, 216D (e.g., of two or more sensors 116E, 116J, 116K) may meet at a virtual intersection point 224.

The vehicle 100 may include a number of sensors 116E, 116G, 116H, 116J, 116K disposed proximal to the rear 120 of the vehicle 100. These sensors can include, but are in no way limited to, an imaging sensor, camera, IR, a radio object-detection and ranging sensors, RADAR, RF, ultrasonic sensors, and/or other object-detection sensors. Among other things, these sensors 116E, 116G, 116H, 116J, 116K may detect targets near or approaching the rear of the vehicle 100. For example, another vehicle approaching the rear 120 of the vehicle 100 may be detected by one or more of the ranging and imaging system (e.g., LiDAR) 112, rear-view cameras 116G, 116H, and/or rear facing RADAR sensors 116J, 116K. As described above, the images from the rear-view cameras 116G, 116H may be processed to generate a stereo view (e.g., providing depth associated with an object or environment, etc.) for targets visible to both cameras 116G, 116H. As another example, the vehicle 100 may be driving and one or more of the ranging and imaging system 112, front-facing cameras 116A, 116F, front-facing RADAR sensors 116B, and/or ultrasonic sensors 116C may detect targets in front of the vehicle 100. This approach may provide critical sensor information to a vehicle control system in at least one of the autonomous driving levels described above.

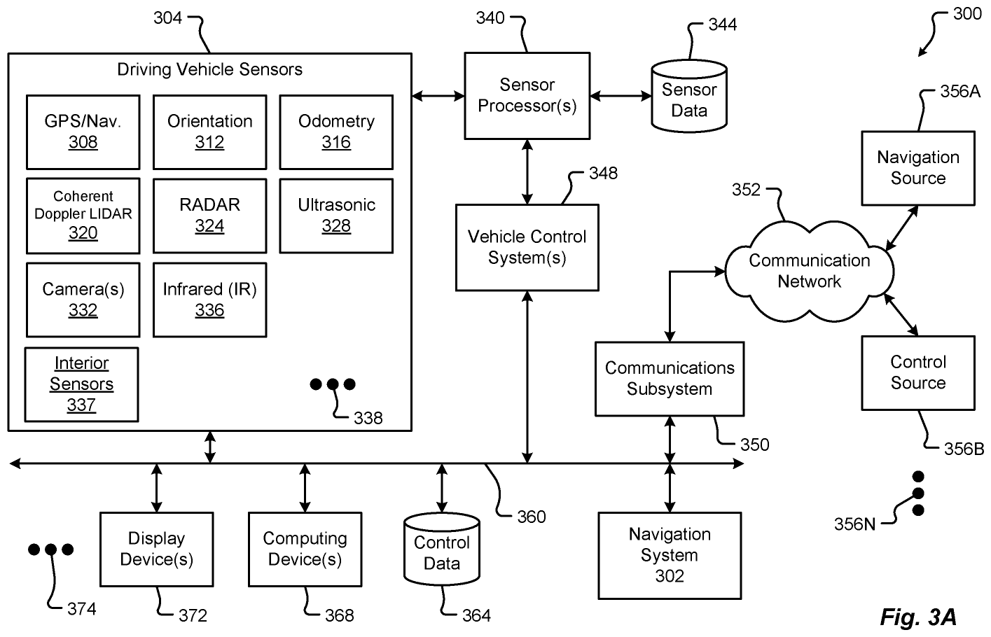

FIGS. 3A and 3B are block diagrams of an embodiment of a communication system 300 of the vehicle 100 in accordance with embodiments of the present disclosure. The communication system 300 may include one or more vehicle driving vehicle sensors and systems 304, sensor processors 340, sensor data memory 344, vehicle control system 348, communications subsystem 350, control data 364, computing devices 368, display devices 372, and other components 374 that may be associated with a vehicle 100. These associated components may be electrically and/or communicatively coupled to one another via at least one bus 360. In some embodiments, the one or more associated components may send and/or receive signals across a communication network 352 to at least one of a navigation source 356A, a control source 356B, or some other entity 356N.

In accordance with at least some embodiments of the present disclosure, the communication network 352 may comprise any type of known communication medium or collection of communication media and may use any type of protocols, such as SIP, TCP/IP, SNA, IPX, AppleTalk, and the like, to transport messages between endpoints. The communication network 352 may include wired and/or wireless communication technologies. The Internet is an example of the communication network 352 that constitutes an Internet Protocol (IP) network consisting of many computers, computing networks, and other communication devices located all over the world, which are connected through many telephone systems and other means. Other examples of the communication network 352 include, without limitation, a standard Plain Old Telephone System (POTS), an Integrated Services Digital Network (ISDN), the Public Switched Telephone Network (PSTN), a Local Area Network (LAN), such as an Ethernet network, a Token-Ring network and/or the like, a Wide Area Network (WAN), a virtual network, including without limitation a virtual private network (“VPN”); the Internet, an intranet, an extranet, a cellular network, an infra-red network; a wireless network (e.g., a network operating under any of the IEEE 802.9 suite of protocols, the Bluetooth® protocol known in the art, and/or any other wireless protocol), and any other type of packet-switched or circuit-switched network known in the art and/or any combination of these and/or other networks. In addition, it can be appreciated that the communication network 352 need not be limited to any one network type, and instead may be comprised of a number of different networks and/or network types. The communication network 352 may comprise a number of different communication media such as coaxial cable, copper cable/wire, fiber-optic cable, antennas for transmitting/receiving wireless messages, and combinations thereof.

The driving vehicle sensors and systems 304 may include at least one navigation 308 (e.g., global positioning system (GPS), etc.), orientation 312, odometry 316, LiDAR 320, RADAR 324, ultrasonic 328, camera 332, infrared (IR) 336, and/or other sensor or system 338. These driving vehicle sensors and systems 304 may be similar, if not identical, to the sensors and systems 116A-K, 112 described in conjunction with FIGS. 1 and 2.

The navigation sensor 308 may include one or more sensors having receivers and antennas that are configured to utilize a satellite-based navigation system 302 including a network of navigation satellites capable of providing geolocation and time information to at least one component of the vehicle 100. Examples of the navigation sensor 308 as described herein may include, but are not limited to, at least one of Garmin® GLO™ family of GPS and GLONASS combination sensors, Garmin® GPS 15x™ family of sensors, Garmin® GPS 16x™ family of sensors with high-sensitivity receiver and antenna, Garmin® GPS 18x OEM family of high-sensitivity GPS sensors, Dewetron DEWE-VGPS series of GPS sensors, GlobalSat 1-Hz series of GPS sensors, other industry-equivalent navigation sensors and/or systems, and may perform navigational and/or geolocation functions using any known or future-developed standard and/or architecture.

The orientation sensor 312 may include one or more sensors configured to determine an orientation of the vehicle 100 relative to at least one reference point. In some embodiments, the orientation sensor 312 may include at least one pressure transducer, stress/strain gauge, accelerometer, gyroscope, and/or geomagnetic sensor. Examples of the orientation sensor 312 as described herein may include, but are not limited to, at least one of Bosch Sensortec BMX 160 series low-power absolute orientation sensors, Bosch Sensortec BMX055 9-axis sensors, Bosch Sensortec BMI055 6-axis inertial sensors, Bosch Sensortec BMI160 6-axis inertial sensors, Bosch Sensortec BMF055 9-axis inertial sensors (accelerometer, gyroscope, and magnetometer) with integrated Cortex M0+ microcontroller, Bosch Sensortec BMP280 absolute barometric pressure sensors, Infineon TLV493D-A1B6 3D magnetic sensors, Infineon TLI493D-W1B6 3D magnetic sensors, Infineon TL family of 3D magnetic sensors, Murata Electronics SCC2000 series combined gyro sensor and accelerometer, Murata Electronics SCC1300 series combined gyro sensor and accelerometer, other industry-equivalent orientation sensors and/or systems, which may perform orientation detection and/or determination functions using any known or future-developed standard and/or architecture.

The odometry sensor and/or system 316 may include one or more components that is configured to determine a change in position of the vehicle 100 over time. In some embodiments, the odometry system 316 may utilize data from one or more other sensors and/or systems 304 in determining a position (e.g., distance, location, etc.) of the vehicle 100 relative to a previously measured position for the vehicle 100. Additionally, or alternatively, the odometry sensors 316 may include one or more encoders, Hall speed sensors, and/or other measurement sensors/devices configured to measure a wheel speed, rotation, and/or number of revolutions made over time. Examples of the odometry sensor/system 316 as described herein may include, but are not limited to, at least one of Infineon TLE4924/26/27/28C high-performance speed sensors, Infineon TL4941plusC(B) single chip differential Hall wheel-speed sensors, Infineon TL5041plusC Giant Magnetoresistance (GMR) effect sensors, Infineon TL family of magnetic sensors, EPC Model 25SP Accu-CoderPro™ incremental shaft encoders, EPC Model 30M compact incremental encoders with advanced magnetic sensing and signal processing technology, EPC Model 925 absolute shaft encoders, EPC Model 958 absolute shaft encoders, EPC Model MA36S/MA63S/SA36S absolute shaft encoders, Dynapar™ F18 commutating optical encoder, Dynapar™ HS35R family of phased array encoder sensors, other industry-equivalent odometry sensors and/or systems, and may perform change in position detection and/or determination functions using any known or future-developed standard and/or architecture.

The LiDAR sensor/system 320 may include one or more components configured to measure distances to targets using laser illumination. In some embodiments, the LiDAR sensor/system 320 may provide 3D imaging data of an environment around the vehicle 100. The imaging data may be processed to generate a full 360-degree view of the environment around the vehicle 100. The LiDAR sensor/system 320 may include a laser light generator configured to generate a plurality of target illumination laser beams (e.g., laser light channels). In some embodiments, this plurality of laser beams may be aimed at, or directed to, a rotating reflective surface (e.g., a mirror) and guided outwardly from the LiDAR sensor/system 320 into a measurement environment. The rotating reflective surface may be configured to continually rotate 360 degrees about an axis, such that the plurality of laser beams is directed in a full 360-degree range around the vehicle 100. A photodiode receiver of the LiDAR sensor/system 320 may detect when light from the plurality of laser beams emitted into the measurement environment returns (e.g., reflected echo) to the LiDAR sensor/system 320. The LiDAR sensor/system 320 may calculate, based on a time associated with the emission of light to the detected return of light, a distance from the vehicle 100 to the illuminated target. In some embodiments, the LiDAR sensor/system 320 may generate over 2.0 million points per second and have an effective operational range of at least 100 meters. Examples of the LiDAR sensor/system 320 as described herein may include, but are not limited to, at least one of Velodyne® LiDAR™ HDL-64E 64-channel LiDAR sensors, Velodyne® LiDAR™ HDL-32E 32-channel LiDAR sensors, Velodyne® LiDAR™ PUCK™ VLP-16 16-channel LiDAR sensors, Leica Geosystems Pegasus:Two mobile sensor platform, Garmin® LiDAR-Lite v3 measurement sensor, Quanergy M8 LiDAR sensors, Quanergy S3 solid state LiDAR sensor, LeddarTech® LeddarVU compact solid state fixed-beam LIDAR sensors, other industry-equivalent LiDAR sensors and/or systems, and may perform illuminated target and/or obstacle detection in an environment around the vehicle 100 using any known or future-developed standard and/or architecture.

The RADAR sensors 324 may include one or more radio components that are configured to detect objects/targets in an environment of the vehicle 100. In some embodiments, the RADAR sensors 324 may determine a distance, position, and/or movement vector (e.g., angle, speed, etc.) associated with a target over time. The RADAR sensors 324 may include a transmitter configured to generate and emit electromagnetic waves (e.g., radio, microwaves, etc.) and a receiver configured to detect returned electromagnetic waves. In some embodiments, the RADAR sensors 324 may include at least one processor configured to interpret the returned electromagnetic waves and determine locational properties of targets. Examples of the RADAR sensors 324 as described herein may include, but are not limited to, at least one of Infineon RASIC™ RTN7735PL transmitter and RRN7745PL/46PL receiver sensors, Autoliv ASP Vehicle RADAR sensors, Delphi L2C0051TR 77 GHz ESR Electronically Scanning RADAR sensors, Fujitsu Ten Ltd. Automotive Compact 77 GHz 3D Electronic Scan Millimeter Wave RADAR sensors, other industry-equivalent RADAR sensors and/or systems and may perform radio target and/or obstacle detection in an environment around the vehicle 100 using any known or future-developed standard and/or architecture.

The ultrasonic sensors 328 may include one or more components that are configured to detect objects/targets in an environment of the vehicle 100. In some embodiments, the ultrasonic sensors 328 may determine a distance, position, and/or movement vector (e.g., angle, speed, etc.) associated with a target over time. The ultrasonic sensors 328 may include an ultrasonic transmitter and receiver, or transceiver, configured to generate and emit ultrasound waves and interpret returned echoes of those waves. In some embodiments, the ultrasonic sensors 328 may include at least one processor configured to interpret the returned ultrasonic waves and determine locational properties of targets. Examples of the ultrasonic sensors 328 as described herein may include, but are not limited to, at least one of Texas Instruments TIDA-00151 automotive ultrasonic sensor interface IC sensors, MaxBotix® MB8450 ultrasonic proximity sensor, MaxBotix® ParkSonar™-EZ ultrasonic proximity sensors, Murata Electronics MA40H1S-R open-structure ultrasonic sensors, Murata Electronics MA40S4R/S open-structure ultrasonic sensors, Murata Electronics MA58MF14-7N waterproof ultrasonic sensors, other industry-equivalent ultrasonic sensors and/or systems, and may perform ultrasonic target and/or obstacle detection in an environment around the vehicle 100 using any known or future-developed standard and/or architecture.

The camera sensors 332 may include one or more components configured to detect image information associated with an environment of the vehicle 100. In some embodiments, the camera sensors 332 may include a lens, filter, image sensor, and/or a digital image processor. It is an aspect of the present disclosure that multiple camera sensors 332 may be used together to generate stereo images providing depth measurements. Examples of the camera sensors 332 as described herein may include, but are not limited to, at least one of ON Semiconductor® MT9V024 Global Shutter VGA GS CMOS image sensors, Teledyne DALSA Falcon2 camera sensors, CMOSIS CMV50000 high-speed CMOS image sensors, other industry-equivalent camera sensors and/or systems and may perform visual target and/or obstacle detection in an environment around the vehicle 100 using any known or future-developed standard and/or architecture.

The infrared (IR) sensors 336 may include one or more components configured to detect image information associated with an environment of the vehicle 100. The IR sensors 336 may be configured to detect targets in low-light, dark, or poorly lit environments. The IR sensors 336 may include an IR light emitting element (e.g., IR light emitting diode (LED), etc.), and an IR photodiode. In some embodiments, the IR photodiode may be configured to detect returned IR light at or about the same wavelength to that emitted by the IR light emitting element. In some embodiments, the IR sensors 336 may include at least one processor configured to interpret the returned IR light and determine locational properties of targets. The IR sensors 336 may be configured to detect and/or measure a temperature associated with a target (e.g., an object, pedestrian, other vehicle, etc.). Examples of IR sensors 336 as described herein may include, but are not limited to, at least one of Opto Diode lead-salt IR array sensors, Opto Diode OD-850 Near-IR LED sensors, Opto Diode SA/SHA727 steady state IR emitters and IR detectors, FLIR® LS microbolometer sensors, FLIR® TacFLIR 380-HD InSb MWIR FPA and HD MWIR thermal sensors, FLIR® VOx 640×480 pixel detector sensors, Delphi IR sensors, other industry-equivalent IR sensors and/or systems, and may perform IR visual target and/or obstacle detection in an environment around the vehicle 100 using any known or future-developed standard and/or architecture.

The vehicle 100 can also include one or more interior sensors 337. Interior sensors 337 can measure characteristics of the inside environment of the vehicle 100. The interior sensors 337 may be as described in conjunction with FIG. 3B.

In some embodiments, the driving vehicle sensors, and systems 304 may include other sensors 338 and/or combinations of the sensors described above. Additionally, or alternatively, one or more of the sensors described above may include one or more processors configured to process and/or interpret signals detected by the one or more sensors. In some embodiments, the processing of at least some sensor information provided by the vehicle sensors and systems 304 may be processed by at least one sensor processor 340. Raw and/or processed sensor data may be stored in a sensor data memory 344 storage medium. In some embodiments, the sensor data memory 344 may store instructions used by the sensor processor 340 for processing sensor information provided by the sensors and systems 304. In any event, the sensor data memory 344 may be a disk drive, optical storage device, solid-state storage device such as a random-access memory (“RAM”) and/or a read-only memory (“ROM”), which can be programmable, flash-updateable, and/or the like.

The vehicle control system 348 may receive processed sensor information from the sensor processor 340 and determine to control an aspect of the vehicle 100. Controlling an aspect of the vehicle 100 may include presenting information via one or more display devices 372 associated with the vehicle, sending commands to one or more computing devices 368 associated with the vehicle, and/or controlling a driving operation of the vehicle. In some embodiments, the vehicle control system 348 may correspond to one or more computing systems that control driving operations of the vehicle 100 in accordance with the Levels of driving autonomy described above. In one embodiment, the vehicle control system 348 may operate a speed of the vehicle 100 by controlling an output signal to the accelerator and/or braking system of the vehicle. In this example, the vehicle control system 348 may receive sensor data describing an environment surrounding the vehicle 100 and, based on the sensor data received, determine to adjust the acceleration, power output, and/or braking of the vehicle 100. The vehicle control system 348 may additionally control steering and/or other driving functions of the vehicle 100.

The vehicle control system 348 may communicate, in real-time, with the driving sensors and systems 304 forming a feedback loop. In particular, upon receiving sensor information describing a condition of targets in the environment surrounding the vehicle 100, the vehicle control system 348 may autonomously make changes to a driving operation of the vehicle 100. The vehicle control system 348 may then receive subsequent sensor information describing any change to the condition of the targets detected in the environment as a result of the changes made to the driving operation. This continual cycle of observation (e.g., via the sensors, etc.) and action (e.g., selected control or non-control of vehicle operations, etc.) allows the vehicle 100 to operate autonomously in the environment.

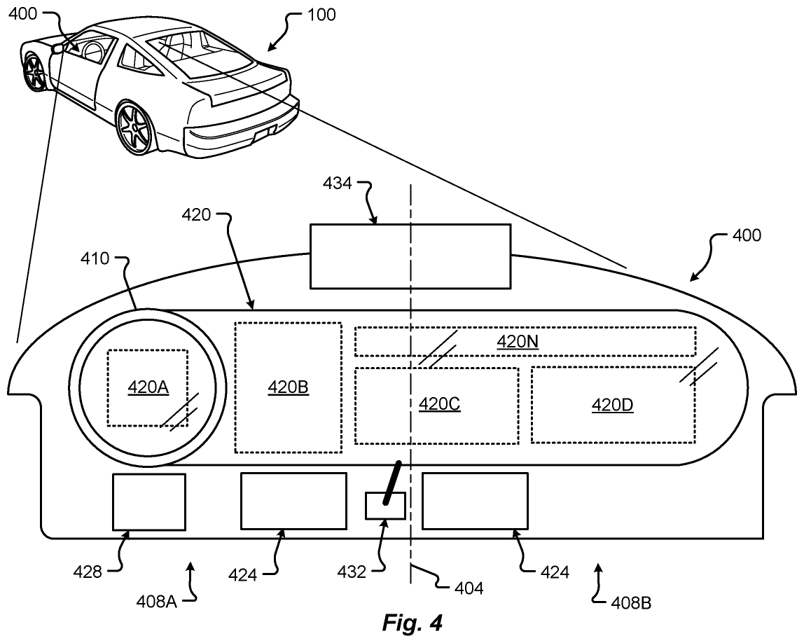

In some embodiments, the one or more components of the vehicle 100 (e.g., the driving vehicle sensors 304, vehicle control system 348, display devices 372, etc.) may communicate across the communication network 352 to one or more entities 356A-N via a communications subsystem 350 of the vehicle 100. Embodiments of the communications subsystem 350 are described in greater detail in conjunction with FIG. 5. For instance, the navigation sensors 308 may receive global positioning, location, and/or navigational information from a navigation source 356A. In some embodiments, the navigation source 356A may be a global navigation satellite system (GNSS) similar, if not identical, to NAVSTAR GPS, GLONASS, EU Galileo, and/or the BeiDou Navigation Satellite System (BDS) to name a few.

In some embodiments, the vehicle control system 348 may receive control information from one or more control sources 356B. The control source 356B may provide vehicle control information including autonomous driving control commands, vehicle operation override control commands, and the like. The control source 356B may correspond to an autonomous vehicle control system, a traffic control system, an administrative control entity, and/or some other controlling server. It is an aspect of the present disclosure that the vehicle control system 348 and/or other components of the vehicle 100 may exchange communications with the control source 356B across the communication network 352 and via the communications subsystem 350.

Information associated with controlling driving operations of the vehicle 100 may be stored in a control data memory 364 storage medium. The control data memory 364 may store instructions used by the vehicle control system 348 for controlling driving operations of the vehicle 100, historical control information, autonomous driving control rules, and the like. In some embodiments, the control data memory 364 may be a disk drive, optical storage device, solid-state storage device such as a random-access memory (“RAM”) and/or a read-only memory (“ROM”), which can be programmable, flash-updateable, and/or the like.

In some embodiments, the vehicle control system 348 may be configured to access data necessary for implementing a depth estimation module, a background modeling system, an image inpainting system, and for performing a variety of tasks relating to image processing such as generating histograms as described herein. In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

FIG. 3B shows a block diagram of an embodiment of interior sensors 337 for a vehicle 100. The interior sensors 337 may be arranged into one or more groups, based at least partially on the function of the interior sensors 337. For example, the interior space of a vehicle 100 may include environmental sensors, user interface sensor(s), and/or safety sensors. Additionally, or alternatively, there may be sensors associated with various devices inside the vehicle (e.g., smart phones, tablets, mobile computers, wearables, etc.)

Environmental sensors may comprise sensors configured to collect data relating to the internal environment of a vehicle 100. Examples of environmental sensors may include one or more of but are not limited to: oxygen/air sensors 301, temperature sensors 303, humidity sensors 305, light/photo sensors 307, and more. The oxygen/air sensors 301 may be configured to detect a quality or characteristic of the air in the interior space 150 of the vehicle 100 (e.g., ratios and/or types of gasses comprising the air inside the vehicle 100, dangerous gas levels, safe gas levels, etc.). Temperature sensors 303 may be configured to detect temperature readings of one or more objects, zones 216, and/or areas of a vehicle 100. Humidity sensors 305 may detect an amount of water vapor present in the air inside the vehicle 100. The light/photo sensors 307 can detect an amount of light present in the vehicle 100. Further, the light/photo sensors 307 may be configured to detect various levels of light intensity associated with light in the vehicle 100.

User interface sensors may comprise sensors configured to collect data relating to one or more users (e.g., a driver and/or passenger(s)) in a vehicle 100. As can be appreciated, the user interface sensors may include sensors that are configured to collect data from zones 216 in one or more areas of the vehicle 100. Examples of user interface sensors may include one or more of, but are not limited to: infrared sensors 309, motion sensors 311, weight sensors 313, wireless network sensors 315, biometric sensors 317, camera (or image) sensors 319, audio sensors 321, and more.

Infrared sensors 309 may be used to measure IR light irradiating from at least one surface, user, or another object in the vehicle 100. Among other things, the Infrared sensors 309 may be used to measure temperatures, form images (especially in low light conditions), identify zones 216, and even detect motion in the vehicle 100.

The motion sensors 311 may detect motion and/or movement of objects inside the vehicle 100. Optionally, the motion sensors 311 may be used alone or in combination to detect movement. For example, a user may be operating a vehicle 100 (e.g., while driving, etc.) when a passenger in the rear of the vehicle 100 unbuckles a safety belt and proceeds to move about the vehicle 100. In this example, the movement of the passenger could be detected by the motion sensors 311. In response to detecting the movement and/or the direction associated with the movement, the passenger may be prevented from interfacing with and/or accessing at least some of the vehicle control features. As can be appreciated, the user may be alerted of the movement/motion such that the user can act to prevent the passenger from interfering with the vehicle controls. Optionally, the number of motion sensors in a vehicle may be increased to increase an accuracy associated with motion detected in the vehicle 100.

Weight sensors 313 may be employed to collect data relating to objects and/or users in various areas of the vehicle 100. In some cases, the weight sensors 313 may be included in the seats and/or floor of a vehicle 100. Optionally, the vehicle 100 may include a wireless network sensor 315. This sensor 315 may be configured to detect one or more wireless network(s) inside the vehicle 100. Examples of wireless networks may include, but are not limited to, wireless communications utilizing Bluetooth®, Wi-Fi™, ZigBee, IEEE 802.11, and other wireless technology standards. For example, a mobile hotspot may be detected inside the vehicle 100 via the wireless network sensor 315. In this case, the vehicle 100 may determine to utilize and/or share the mobile hotspot detected via/with one or more other devices associated with the vehicle 100.

Biometric sensors 317 may be employed to identify and/or record characteristics associated with a user. It is anticipated that biometric sensors 317 can include at least one of image sensors, IR sensors, fingerprint readers, weight sensors, load cells, force transducers, heart rate monitors, blood pressure monitors, and the like as provided herein.

The camera sensors 319 may record still images, video, and/or combinations thereof. Camera sensors 319 may be used alone or in combination to identify objects, users, and/or other features, inside the vehicle 100. Two or more camera sensors 319 may be used in combination to form, among other things, stereo and/or three-dimensional (3D) images. The stereo images can be recorded and/or used to determine depth associated with objects and/or users in a vehicle 100. Further, the camera sensors 319 used in combination may determine the complex geometry associated with identifying characteristics of a user. For example, the camera sensors 319 may be used to determine dimensions between various features of a user's face (e.g., the depth/distance from a user's nose to a user's cheeks, a linear distance between the center of a user's eyes, and more). These dimensions may be used to verify, record, and even modify characteristics that serve to identify a user. The camera sensors 319 may also be used to determine movement associated with objects and/or users within the vehicle 100. It should be appreciated that the number of image sensors used in a vehicle 100 may be increased to provide greater dimensional accuracy and/or views of a detected image in the vehicle 100.

The audio sensors 321 may be configured to receive audio input from a user of the vehicle 100. The audio input from a user may correspond to voice commands, conversations detected in the vehicle 100, phone calls made in the vehicle 100, and/or other audible expressions made in the vehicle 100. Audio sensors 321 may include, but are not limited to, microphones and other types of acoustic-to-electric transducers or sensors. Optionally, the interior audio sensors 321 may be configured to receive and convert sound waves into an equivalent analog or digital signal. The interior audio sensors 321 may serve to determine one or more locations associated with various sounds in the vehicle 100. The location of the sounds may be determined based on a comparison of volume levels, intensity, and the like, between sounds detected by two or more interior audio sensors 321. For instance, a first audio sensors 321 may be located in a first area of the vehicle 100 and a second audio sensors 321 may be located in a second area of the vehicle 100. If a sound is detected at a first volume level by the first audio sensors 321 A and a second, higher, volume level by the second audio sensors 321 in the second area of the vehicle 100, the sound may be determined to be closer to the second area of the vehicle 100. As can be appreciated, the number of sound receivers used in a vehicle 100 may be increased (e.g., more than two, etc.) to increase measurement accuracy surrounding sound detection and location, or source, of the sound (e.g., via triangulation, etc.).

The safety sensors may comprise sensors configured to collect data relating to the safety of a user and/or one or more components of a vehicle 100. Examples of safety sensors may include one or more of, but are not limited to: force sensors 325, mechanical motion sensors 327, orientation sensors 329, restraint sensors 331, and more.

The force sensors 325 may include one or more sensors inside the vehicle 100 configured to detect a force observed in the vehicle 100. One example of a force sensor 325 may include a force transducer that converts measured forces (e.g., force, weight, pressure, etc.) into output signals. Mechanical motion sensors 327 may correspond to encoders, accelerometers, damped masses, and the like. Optionally, the mechanical motion sensors 327 may be adapted to measure the force of gravity (i.e., G-force) as observed inside the vehicle 100. Measuring the G-force observed inside a vehicle 100 can provide valuable information related to a vehicle's acceleration, deceleration, collisions, and/or forces that may have been suffered by one or more users in the vehicle 100. Orientation sensors 329 can include accelerometers, gyroscopes, magnetic sensors, and the like that are configured to detect an orientation associated with the vehicle 100.

The restraint sensors 331 may correspond to sensors associated with one or more restraint devices and/or systems in a vehicle 100. Seatbelts and airbags are examples of restraint devices and/or systems. As can be appreciated, the restraint devices and/or systems may be associated with one or more sensors that are configured to detect a state of the device/system. The state may include extension, engagement, retraction, disengagement, deployment, and/or other electrical or mechanical conditions associated with the device/system.

The associated device sensors 323 can include any sensors that are associated with a device in the vehicle 100. As previously stated, typical devices may include smart phones, tablets, laptops, mobile computers, and the like. It is anticipated that the various sensors associated with these devices can be employed by the vehicle control system 348. For example, a typical smart phone can include, an image sensor, an IR sensor, audio sensor, gyroscope, accelerometer, wireless network sensor, fingerprint reader, and more. It is an aspect of the present disclosure that one or more of these associated device sensors 323 may be used by one or more subsystems of the vehicle 100.

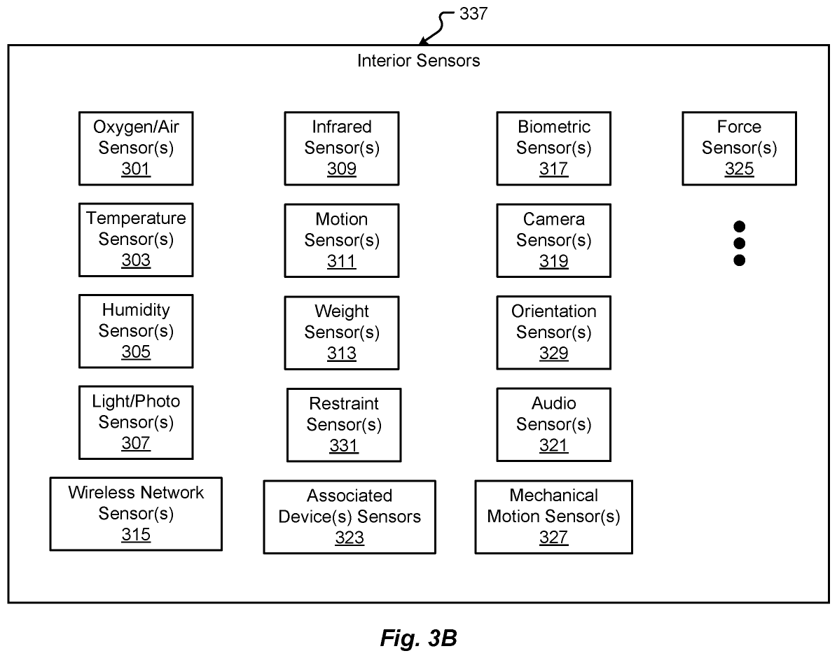

FIG. 4 shows one embodiment of the instrument panel 400 of the vehicle 100. The instrument panel 400 of vehicle 100 comprises a steering wheel 410, a vehicle operational display 420 (e.g., configured to present and/or display driving data such as speed, measured air resistance, vehicle information, entertainment information, etc.), one or more auxiliary displays 424 (e.g., configured to present and/or display information segregated from the operational display 420, entertainment applications, movies, music, etc.), a heads-up display 434 (e.g., configured to display any information previously described including, but in no way limited to, guidance information such as route to destination, or obstacle warning information to warn of a potential collision, or some or all primary vehicle operational data such as speed, resistance, etc.), a power management display 428 (e.g., configured to display data corresponding to electric power levels of vehicle 100, reserve power, charging status, etc.), and an input device 432 (e.g., a controller, touchscreen, or other interface device configured to interface with one or more displays in the instrument panel or components of the vehicle 100. The input device 432 may be configured as a joystick, mouse, touchpad, tablet, 3D gestures capture device, etc.). In some embodiments, the input device 432 may be used to manually maneuver a portion of the vehicle 100 into a charging position (e.g., moving a charging plate to a desired separation distance, etc.).

While one or more of displays of instrument panel 400 may be touch-screen displays, it should be appreciated that the vehicle operational display may be a display incapable of receiving touch input. For instance, the operational display 420 that spans across an interior space centerline 404 and across both a first zone 408A and a second zone 408B may be isolated from receiving input from touch, especially from a passenger. In some cases, a display that provides vehicle operation or critical systems information and interface may be restricted from receiving touch input and/or be configured as a non-touch display. This type of configuration can prevent dangerous mistakes in providing touch input where such input may cause an accident or unwanted control.

In some embodiments, one or more displays of the instrument panel 400 may be mobile devices and/or applications residing on a mobile device such as a smart phone. Additionally, or alternatively, any of the information described herein may be presented to one or more portions 420A-N of the operational display 420 or other display 424, 428, 434. In one embodiment, one or more displays of the instrument panel 400 may be physically separated or detached from the instrument panel 400. In some cases, a detachable display may remain tethered to the instrument panel.

The portions 420A-N of the operational display 420 may be dynamically reconfigured and/or resized to suit any display of information as described. Additionally, or alternatively, the number of portions 420A-N used to visually present information via the operational display 420 may be dynamically increased or decreased as required and are not limited to the configurations shown.

FIG. 5 illustrates a hardware diagram of communications componentry that can be optionally associated with the vehicle 100 in accordance with embodiments of the present disclosure.

The communications componentry can include one or more wired or wireless devices such as a transceiver(s) and/or modem that allows communications not only between the various systems disclosed herein but also with other devices, such as devices on a network, and/or on a distributed network such as the Internet and/or in the cloud and/or with other vehicle(s).

The communications subsystem 350 can also include inter- and intra-vehicle communications capabilities such as hotspot and/or access point connectivity for any one or more of the vehicle occupants and/or vehicle-to-vehicle communications.

Additionally, and while not specifically illustrated, the communications subsystem 350 can include one or more communications links (that can be wired or wireless) and/or communications busses (managed by the bus manager 574), including one or more of CANbus, OBD-II, ARCINC 429, Byteflight, CAN (Controller Area Network), D2B (Domestic Digital Bus), FlexRay, DC-BUS, IDB-1394, IEBus, I2C, ISO 9141-1/-2, J1708, J1587, J1850, J1939, ISO 11783, Keyword Protocol 2000, LIN (Local Interconnect Network), MOST (Media Oriented Systems Transport), Multifunction Vehicle Bus, SMARTwireX, SPI, VAN (Vehicle Area Network), and the like or in general any communications protocol and/or standard(s).

The various protocols and communications can be communicated one or more of wirelessly and/or over transmission media such as single wire, twisted pair, fiber optic, IEEE 1394, MIL-STD-1553, MIL-STD-1773, power-line communication, or the like. (All of the above standards and protocols are incorporated herein by reference in their entirety.)

As discussed, the communications subsystem 350 enables communications between any of the inter-vehicle systems and subsystems as well as communications with non-collocated resources, such as those reachable over a network such as the Internet.

The communications subsystem 350, in addition to well-known componentry (which has been omitted for clarity), includes interconnected elements including one or more of: one or more antennas 504, an interleaver/deinterleaver 508, an analog front end (AFE) 512, memory/storage/cache 516, controller/microprocessor 520, MAC circuitry 522, modulator/demodulator 524, encoder/decoder 528, a plurality of connectivity managers 534, 558, 562, 566, GPU 540, accelerator 544, a multiplexer/demultiplexer 552, transmitter 570, receiver 572 and additional wireless radio components such as a Wi-Fi PHY/Bluetooth® module 580, a Wi-Fi/BT MAC module 584, additional transmitter(s) 588 and additional receiver(s) 592. The various elements in the device 350 are connected by one or more links/busses 5 (not shown, again for sake of clarity).

The device 350 can have one more antennas 504, for use in wireless communications such as multi-input multi-output (MIMO) communications, multi-user multi-input multi-output (MU-MIMO) communications Bluetooth®, LTE, 4G, 5G, Near-Field Communication (NFC), etc., and in general for any type of wireless communications. The antenna(s) 504 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users for example within the vehicle 100 and/or in another vehicle.

Antenna(s) 504 generally interact with the Analog Front End (AFE) 512, which is needed to enable the correct processing of the received modulated signal and signal conditioning for a transmitted signal. The AFE 512 can be functionally located between the antenna and a digital baseband system in order to convert the analog signal into a digital signal for processing and vice-versa.

The subsystem 350 can also include a controller/microprocessor 520 and a memory/storage/cache 516. The subsystem 350 can interact with the memory/storage/cache 516 which may store information and operations necessary for configuring and transmitting or receiving the information described herein. The memory/storage/cache 516 may also be used in connection with the execution of application programming or instructions by the controller/microprocessor 520, and for temporary or long-term storage of program instructions and/or data. As examples, the memory/storage/cache 520 may comprise a computer-readable device, RAM, ROM, DRAM, SDRAM, and/or other storage device(s) and media.

The controller/microprocessor 520 may comprise a general-purpose programmable processor or controller for executing application programming or instructions related to the subsystem 350. Furthermore, the controller/microprocessor 520 can perform operations for configuring and transmitting/receiving information as described herein. The controller/microprocessor 520 may include multiple processor cores, and/or implement multiple virtual processors. Optionally, the controller/microprocessor 520 may include multiple physical processors. By way of example, the controller/microprocessor 520 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The subsystem 350 can further include a transmitter(s) 570, 588 and receiver(s) 572, 592 which can transmit and receive signals, respectively, to and from other devices, subsystems and/or other destinations using the one or more antennas 504 and/or links/busses. Included in the subsystem 350 circuitry is the medium access control or MAC Circuitry 522. MAC circuitry 522 provides for controlling access to the wireless medium. In an exemplary embodiment, the MAC circuitry 522 may be arranged to contend for the wireless medium and configure frames or packets for communicating over the wired/wireless medium.

The subsystem 350 can also optionally contain a security module (not shown). This security module can contain information regarding but not limited to, security parameters required to connect the device to one or more other devices or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with an access point and/or another device. The information exchange can occur through encoded messages with the WEP access code often being chosen by the network administrator. WPA is an added security standard that is also used in conjunction with network connectivity with stronger encryption than WEP.

In some embodiments, the communications subsystem 350 also includes a GPU 540, an accelerator 544, a Wi-Fi/BT/BLE (Bluetooth® Low-Energy) PHY module 580 and a Wi-Fi/BT/BLE MAC module 584 and optional wireless transmitter 588 and optional wireless receiver 592. In some embodiments, the GPU 540 may be a graphics processing unit, or visual processing unit, comprising at least one circuit and/or chip that manipulates and changes memory to accelerate the creation of images in a frame buffer for output to at least one display device. The GPU 540 may include one or more of a display device connection port, printed circuit board (PCB), a GPU chip, a metal-oxide-semiconductor field-effect transistor (MOSFET), memory (e.g., single data rate random-access memory (SDRAM), double data rate random-access memory (DDR) RAM, etc., and/or combinations thereof), a secondary processing chip (e.g., handling video out capabilities, processing, and/or other functions in addition to the GPU chip, etc.), a capacitor, heatsink, temperature control or cooling fan, motherboard connection, shielding, and the like.

The various connectivity managers 534, 558, 562, 566 manage and/or coordinate communications between the subsystem 350 and one or more of the systems disclosed herein and one or more other devices/systems. The connectivity managers 534, 558, 562, 566 include a charging connectivity manager 534, a vehicle database connectivity manager 558, a remote operating system connectivity manager 562, and a sensor connectivity manager 566.

The charging connectivity manager 534 can coordinate not only the physical connectivity between the vehicle 100 and a charging device/vehicle but can also communicate with one or more of a power management controller, one or more third parties, and optionally a billing system(s). As an example, the vehicle 100 can establish communications with the charging device/vehicle to one or more of coordinate interconnectivity between the two (e.g., by spatially aligning the charging receptacle on the vehicle with the charger on the charging vehicle) and optionally share navigation information. Once charging is complete, the amount of charge provided can be tracked and optionally forwarded to, for example, a third party for billing. In addition to being able to manage connectivity for the exchange of power, the charging connectivity manager 534 can also communicate information, such as billing information to the charging vehicle and/or a third party. This billing information could be, for example, the owner of the vehicle, the driver/occupant(s) of the vehicle, company information, or in general any information usable to charge the appropriate entity for the power received.

The vehicle database connectivity manager 558 allows the subsystem to receive and/or share information stored in the vehicle database. This information can be shared with other vehicle components/subsystems and/or other entities, such as third parties and/or charging systems. The information can also be shared with one or more vehicle occupant devices, such as an app (application) on a mobile device the driver uses to track information about the vehicle 100 and/or a dealer or service/maintenance provider. In general, any information stored in the vehicle database can optionally be shared with any one or more other devices optionally subject to any privacy or confidentially restrictions.

The remote operating system connectivity manager 562 facilitates communications between the vehicle 100 and any one or more autonomous vehicle systems. These communications can include one or more of navigation information, vehicle information, other vehicle information, weather information, occupant information, or in general any information related to the remote operation of the vehicle 100.

The sensor connectivity manager 566 facilitates communications between any one or more of the vehicle sensors (e.g., the driving vehicle sensors and systems 304, etc.) and any one or more of the other vehicle systems. The sensor connectivity manager 566 can also facilitate communications between any one or more of the sensors and/or vehicle systems and any other destination, such as a service company, app, or in general to any destination where sensor data is needed.

In accordance with one exemplary embodiment, any of the communications discussed herein can be communicated via the conductor(s) used for charging. One exemplary protocol usable for these communications is Power-line communication (PLC). PLC is a communication protocol that uses electrical wiring to simultaneously carry both data, and Alternating Current (AC) electric power transmission or electric power distribution. It is also known as power-line carrier, power-line digital subscriber line (PDSL), mains communication, power-line telecommunications, or power-line networking (PLN). For DC environments in vehicles PLC can be used in conjunction with CAN-bus, LIN-bus over power line (DC-LIN) and DC-BUS.

The communications subsystem can also optionally manage one or more identifiers, such as an IP (Internet Protocol) address(es), associated with the vehicle and one or other system or subsystems or components and/or devices therein. These identifiers can be used in conjunction with any one or more of the connectivity managers as discussed herein.

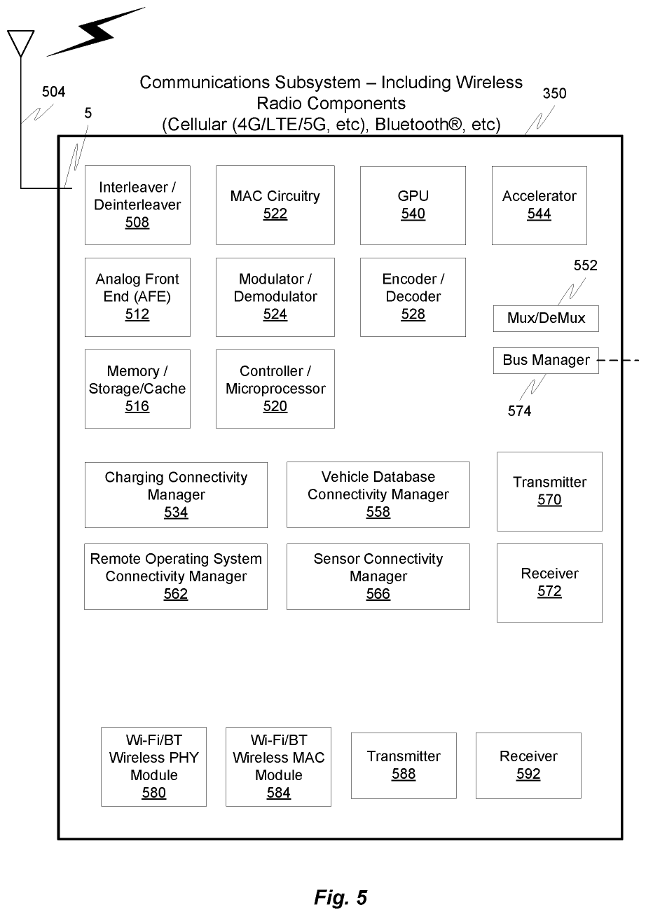

FIG. 6 illustrates a block diagram of a computing environment 600 that may function as the servers, user computers, or other systems provided and described herein. The computing environment 600 includes one or more user computers, or computing devices, such as a vehicle computing device 604, a communication device 608, and/or more 612. The computing devices 604, 608, 612 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially available UNIX® or UNIX-like operating systems. These computing devices 604, 608, 612 may also have any of a variety of applications, including for example, database client and/or server applications, and web browser applications. Alternatively, the computing devices 604, 608, 612 may be any other electronic device, such as a thin-client computer, Internet-enabled mobile telephone, and/or personal digital assistant, capable of communicating via a network 352 and/or displaying and navigating web pages or other types of electronic documents or information. Although the exemplary computing environment 600 is shown with two computing devices, any number of user computers or computing devices may be supported.

The computing environment 600 may also include one or more servers 614, 616. In this example, server 614 is shown as a web server and server 616 is shown as an application server. The web server 614, which may be used to process requests for web pages or other electronic documents from computing devices 604, 608, 612. The web server 614 can be running an operating system including any of those discussed above, as well as any commercially available server operating systems. The web server 614 can also run a variety of server applications, including SIP (Session Initiation Protocol) servers, HTTP(s) servers, FTP servers, CGI servers, database servers, Java® servers, and the like. In some instances, the web server 614 may publish operations available operations as one or more web services.

The computing environment 600 may also include one or more file and or/application servers 616, which can, in addition to an operating system, include one or more applications accessible by a client running on one or more of the computing devices 604, 608, 612. The server(s) 616 and/or 614 may be one or more general purpose computers capable of executing programs or scripts in response to the computing devices 604, 608, 612. As one example, the server 616, 614 may execute one or more web applications. The web application may be implemented as one or more scripts or programs written in any programming language, such as Java®, C, C#®, or C++, and/or any scripting language, such as Perl, Python, or TCL, as well as combinations of any programming/scripting languages. The application server(s) 616 may also include database servers, including without limitation those commercially available from Oracle®, Microsoft®, Sybase®, IBM® and the like, which can process requests from database clients running on a computing device 604, 608, 612.

The web pages created by the server 614 and/or 616 may be forwarded to a computing device 604, 608, 612 via a web (file) server 614, 616. Similarly, the web server 614 may be able to receive web page requests, web services invocations, and/or input data from a computing device 604, 608, 612 (e.g., a user computer, etc.) and can forward the web page requests and/or input data to the web (application) server 616. In further embodiments, the server 616 may function as a file server. Although for ease of description, FIG. 6 illustrates a separate web server 614 and file/application server 616, those skilled in the art will recognize that the functions described with respect to servers 614, 616 may be performed by a single server and/or a plurality of specialized servers, depending on implementation-specific needs and parameters. The computer systems 604, 608, 612, web (file) server 614 and/or web (application) server 616 may function as the system, devices, or components described in FIGS. 1-6.

The computing environment 600 may also include a database 618. The database 618 may reside in a variety of locations. By way of example, database 618 may reside on a storage medium local to (and/or resident in) one or more of the computers 604, 608, 612, 614, 616. Alternatively, it may be remote from any or all of the computers 604, 608, 612, 614, 616, and in communication (e.g., via the network 352) with one or more of these. The database 618 may reside in a storage-area network (“SAN”) familiar to those skilled in the art. Similarly, any necessary files for performing the functions attributed to the computers 604, 608, 612, 614, 616 may be stored locally on the respective computer and/or remotely, as appropriate. The database 618 may be a relational database, such as Oracle 20i®, that is adapted to store, update, and retrieve data in response to SQL-formatted commands.

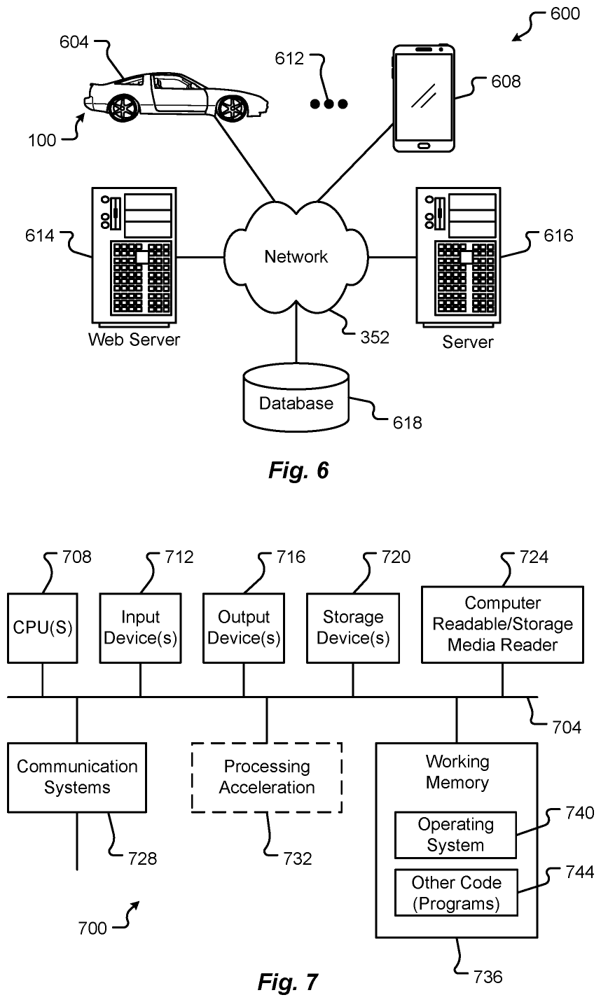

FIG. 7 illustrates one embodiment of a computer system 700 upon which the servers, user computers, computing devices, or other systems or components described above may be deployed or executed. The computer system 700 is shown comprising hardware elements that may be electrically coupled via a bus 704. The hardware elements may include one or more central processing units (CPUs) 708; one or more input devices 712 (e.g., a mouse, a keyboard, etc.); and one or more output devices 716 (e.g., a display device, a printer, etc.). The computer system 700 may also include one or more storage devices 720. By way of example, storage device(s) 720 may be disk drives, optical storage devices, solid-state storage devices such as a random-access memory (“RAM”) and/or a read-only memory (“ROM”), which can be programmable, flash-updateable and/or the like.

The computer system 700 may additionally include a computer-readable storage media reader 724; a communications system 728 (e.g., a modem, a network card (wireless or wired), an infra-red communication device, etc.); and working memory 736, which may include RAM and ROM devices as described above. The computer system 700 may also include a processing acceleration unit 732, which can include a DSP, a special-purpose processor, and/or the like.

The computer-readable storage media reader 724 can further be connected to a computer-readable storage medium, together (and, optionally, in combination with storage device(s) 720) comprehensively representing remote, local, fixed, and/or removable storage devices plus storage media for temporarily and/or more permanently containing computer-readable information. The communications system 728 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information.

The computer system 700 may also comprise software elements, shown as being currently located within a working memory 736, including an operating system 740 and/or other code 744. It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

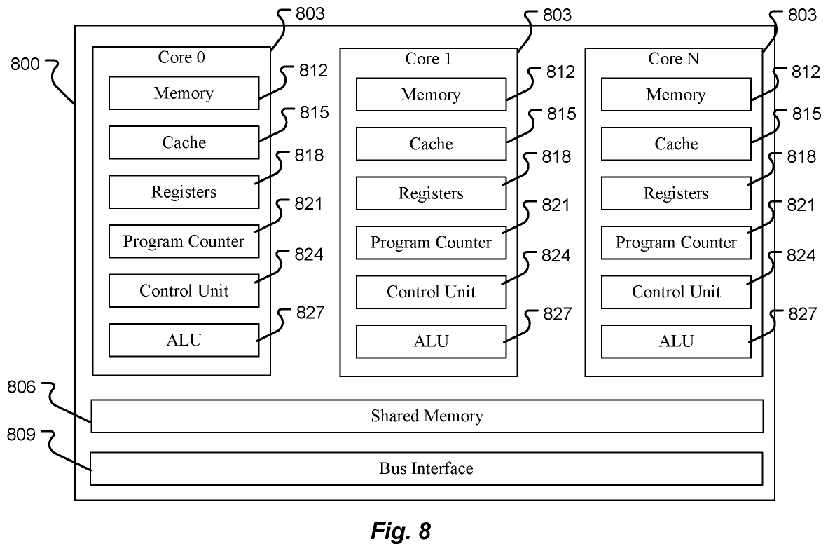

Examples of the processors 340, 708 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJ-S™ processors, other industry-equivalent processors, and may perform computational functions using any known or future-developed standard, instruction set, libraries, and/or architecture. Each of the processors 340, 708 as described herein may comprise multi-core processors such as the multi-core processor 800 illustrated in FIG. 8 and described below.

Embodiments of the present disclosure are directed to systems and methods of implementing a vehicle control system processor health monitor application. While the description provided herein relates to monitoring a processor of a vehicle control system, it should be appreciated the same or similar methods may be used in other environments and to enable functions in addition to or instead of monitoring. As described herein, using an application or process executing on a dedicated core of a multi-core processor, a computer system may be enabled to detect, with an application executing on a first core of a processor, an issue occurring in a task, process, function, firmware, application, etc., performed by or on a second core of the processor, and to respond to the detected issue by saving data, performing reparative tasks, generating reports, transmitting reports, and/or other functions as described herein.

As illustrated in FIG. 8, a multi-core processor 800 may comprise a plurality of cores 803, shared memory 806, and a bus interface 809. A multicore processor 800 as described herein may be a CPU implemented on a single integrated circuit comprising two or more separate processing units or cores which may be configured to read and execute program instructions. In some embodiments, a multicore processor 800 may be a part of a digital signal processing unit, a graphics processing unit, or other type of processing device. The multicore processor 800 may function as a controller for a vehicle control system.

The cores of the multicore processor 800 may be configured to run instructions implementing multithreading or other parallel computing techniques. The multi-core processor 800 may, for example, be a component of a vehicle controller installed on a vehicle.

A single vehicle may, for example, comprise any number of vehicle controllers. Each vehicle controller may comprise one or more multi-core processors 800. While the multi-core processor 800 of FIG. 8 is illustrated as having three cores labeled Core 0, Core 1, and Core N, it should be appreciated the multi-core processor 800 may comprise any number of cores. The core names of Core 0, Core 1, and Core N are included for illustration purposes only and should not be considered as limiting the scope of the disclosure in any way. Each core 803 of the multi-core processor 800 may comprise a number of elements as illustrated in FIG. 8.

Memory 812 of a core 803 of a multi-core processor 800 may comprise a cache 815 or may comprise other memory elements which may be accessible to the core 803. For example, each core 803 may comprise a hierarchy of multiple cache levels (e.g., L1, L2, L3, L4, etc.). A cache 815 of a core 803 of a multi-core processor 800 may comprise a hardware cache which may be used by the core 803 to access data from the shared memory 806 of the processor or other memory devices accessible to the core 815. Memory 812 and cache 815 may store data such as instruction-specific data which may be copies of data from other memory locations.

The processor 800 may further comprise shared memory 806 of the multi-core processor 800 which may be configured to be shared between one or more of the cores 803 of the processor 800. Registers 818 of a core 803 of a multi-core processor 800 may comprise a cache configured to hold values retrieved from one or more memory devices within the processor 800. A program counter 821 of a core 803 of a multi-core processor 800 may comprise a pointer configured to store a number identifying an address of a next instruction to be fetched by the core 803. A control unit 824 of a core 803 of a multi-core processor 800 may comprise a component configured to direct the operation of the core 803 by providing timing and/or control signals.

An arithmetic logic unit (ALU) 827 of a core 803 of a multi-core processor 800 may comprise a digital circuit within the multicore processor 800. The ALU 827 may be configured to perform integer arithmetic and bitwise logic operations. Outputs of the ALU 827 may be stored in one or more registers 827, memory 812, cache 815, or other locations. The ALU 827 may be configured to use data from one or more registers 818 or other memory devices and/or to store data in one or more registers 818 or other memory devices.

It should be appreciated cores 803 of a multi-core processor 800 may comprise other components not illustrated as should be appreciated by one of skill in the art.

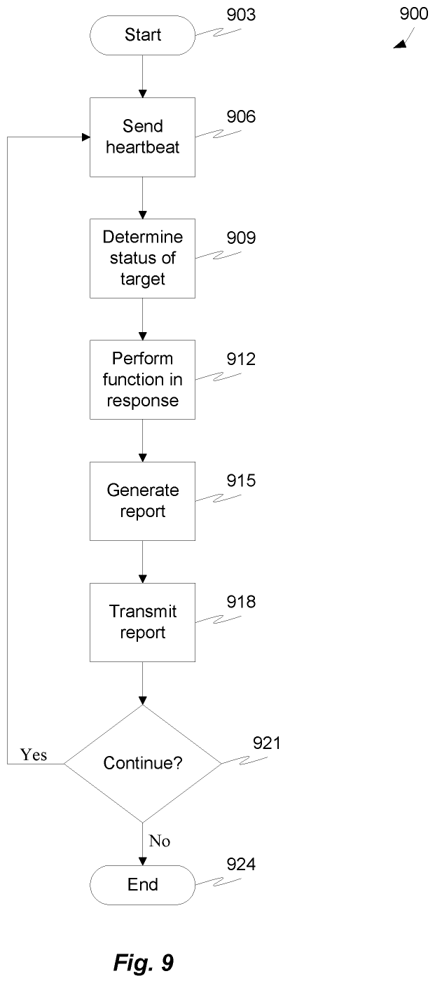

In some embodiments, each core 803 may function as being dedicated to one or more particular tasks. A primary core of the multi-core processor may run vehicle controller firmware or applications relating to basic functions required by the vehicle controller. A secondary core of the multi-core processor may execute a vehicle controller health monitor which may perform a method such as that of FIG. 9, described below. Other cores of the multi-core processor may execute other applications or functions as may be required based on implementation.

The bus interface 809 of the multi-core processor 800 may comprise an internal bus configured to connect any and/or all elements of the process 803 for communication purposes.

A multi-core processor 800, as illustrated in FIG. 8, of a vehicle control system may be configured to perform a method 900 of monitoring the health of one or more cores of the multi-core processor as illustrated in FIG. 9. The method 900 may be performed by an application or process executed by a dedicated core of the multi-core processor. For example, a first core of the multi-core processor may be dedicated to firmware and/or other applications involved in functions performed by the multi-core processor. A second, third, last, etc., core of the multi-core processor may be configured to execute a vehicle controller health detector application which may be enabled to perform steps of the method as described herein.

A vehicle controller health detector application may be capable of monitoring the health of a first or primary core, or any other core, of the multi-core processor. The vehicle controller health detector application may be configured to constantly monitor the health of the monitored core. The health of the monitored core may comprise data such as a state of the processor. The state of the processor may comprise any or all data stored within a register, memory device, or cache of the processor. The health detector application may be configured to continuously store such state information in memory. In some embodiments, state information may be stored for a particular amount of time, e.g., ten seconds, or may be kept indefinitely.

In some embodiments, state information may be stored in memory upon detection of an event as described herein. For example, the health detector application may be configured to continuously update state information stored in memory. The state information stored in memory may be stored only for the past particular amount of time, e.g., ten seconds. Upon detection of an event, the health detector application may save the state information for the particular amount of time such that the state information may be identified at a later time to be used for diagnostics.

In some embodiments, the vehicle monitor application may be configured to operate as a processor system debugger system to detect a potential error occurring in one or more cores of the processor at an early time such that any such error may be resolved prior to the error becoming a greater issue.

By detecting potential errors at an early time, the vehicle monitor application may be enabled to facilitate vehicles in the field to detect errors without resulting in vehicle control systems failing which may require the vehicle to be brought to a repair facility.

In some embodiments, the vehicle monitor application may be configured to operate as a performance profiler. A performance profiler may be configured to profile and/or analyze run-time performance issues. The performance profiler may also or alternatively be configured to collect critical context information such as state information as well as information relating to any application or firmware executing on any core of the processor.

In some embodiments, the vehicle control monitor may be enabled to check a status of any application running on a primary core or other core of the processor. For example, even when a vehicle controller runs normally, a monitor core inside the controller can help to profile and analyze the performance of primary core and report performance profiles back to a backend server and help a company to fine tune software for even better performance.

In some embodiments, the vehicle control monitor may be enabled to operate as a crash analyzer for the processor. The monitor application may be of collecting data in real time and reporting system crash context at time of failure to prevent data being lost in the event of a crash.

By collecting error data immediately at the time of system failure, such data may be used to identify an issue having caused the error to avoid such issues in the future. Such a system operated in contrast to conventional vehicle control systems which must be physically taken to a repair destination for assessment and upon arrival may no longer have the information stored so that the error cannot be identified post-mortem.

As described herein, the monitor application may be configured to transmit a heartbeat signal to one or more other cores of the processor. The heartbeat signal may be a message sent to other cores at a particular interval. The monitor application may be configured to expect a response message following each heartbeat signal. Depending on the timing of the response message—or a missing or not-received response—the monitor application may be enabled to determine whether other cores are operating as expected. For example, if a particular core fails, no response message may be received in response to a heartbeat signal. Based on not receiving the response message, the monitor application may be configured to determine the core having been sent the heartbeat signal has failed.

As illustrated in FIG. 9, a monitor application running on a core of a multi-core processor as illustrated in FIG. 8 may be configured to perform a method 900 of monitoring a different core using heartbeat signals.

At the beginning 903 of the method 900, a monitor application may be executed by a core of the multi-core processor. The monitor application may in some embodiments be executed by a dedicated core of the processor or by a core configured to execute other applications or processes in addition to the monitor application.

The multi-core processor may comprise, in addition to the core executing the monitor application, one or more additional cores, such as a primary core. The one or more additional cores may be configured execute firmware, applications, processes, or other instruct-based systems.

In some embodiments, the multicore processor may be a dual core processor and may comprise a primary core configured to execute firmware to control a vehicle control system comprising the processor and a secondary core configured to execute a monitor application which may perform a method as described herein. As used herein, the term monitor core may refer to any core which is configured to execute a monitor application.

In some embodiments, the method 900 may be performed on a repetitive interval at all times during which the processor is powered-on and running. In some embodiments, the method 900 may be performed in response to instructions from another device or processor. For example, the method 900 may be executed by a monitor core of a multicore processor of a first vehicle control system in response to the monitor core receiving instructions from a second vehicle control system.

At 906, the monitor core may send a heartbeat to one or more other cores of the multicore processor. Sending a heartbeat may comprise generating a packet comprising a heartbeat message. A heartbeat message may be a packet or a field of a packet. A heartbeat message may comprise instructions for a recipient of the message to send a response.

A heartbeat message or a packet comprising a heartbeat message may include a timestamp or other type of identifying characteristic to distinguish the heartbeat from other heartbeats. In this way, a received response may be associated with a transmitted heartbeat

A heartbeat message may be directed to a target core or a target application. For example, a heartbeat message may be directed to a core zero of the multicore processor of which the monitor core belongs. The heartbeat signal may include a header information indicating the packet should be sent to core zero. A heartbeat message may comprise data indicating an address or location to which the heartbeat message is directed. In the case of a heartbeat message being addressed to a plurality of cores, the monitor application may be utilized to monitor a status of each of the plurality of cores and may expect, in response to the heartbeat message, a response from each of the plurality of cores.

In some embodiments, transmitting a heartbeat signal may comprise utilizing a dedicated I/O channel or bus or a shared bus such as the bus illustrated in FIG. 8 to transmit the heartbeat from the monitor core to the target one or more cores. In some embodiments, as opposed to or in addition to sending a heartbeat to a particular core or cores, the monitor core may be configured to send a heartbeat to a particular application or process.

At 909, the monitor core may determine a status of the target core(s), application, process, etc. which was sent the heartbeat message based on receipt (or non-receipt) of a response.

After transmitting the heartbeat message, the monitor core may be configured to wait for a response to the heartbeat signal up to a particular amount of time. For example, a threshold amount of time or a time limit may be set, such as one second, after which the monitor core may cease waiting for a response and may determine no response was received.

A response to a heartbeat signal may be received by the monitor core as a packet, a signal, a message, or other type of data. The response may comprise data such as an indication of the heartbeat packet to which the response packet was sent in response. In some embodiments, the monitor core may be configured to associate a received response with one of the previously transmitted heartbeat signals and to identify a source of the received response. For example, the response may include an identifier labeling a core number, application name, etc. from which the response was sent.

In addition to the threshold amount of time or the time limit for waiting for a response to a sent heartbeat message, the monitor core may also use an intermediate threshold amount of time or time limit to determine whether a received response was received within or outside an expected amount of time. For example, the monitor core may determine a response received within half a second is a timely response, a response received after half a second is a late response, and a response received after one second is not a response.

The monitor core may in some embodiments be configured to determine at what time a response to a heartbeat message was received or to determine how much time elapsed between the heartbeat message being transmitted and the response being received. In some embodiments, a timer may begin upon a heartbeat signal being sent and may stop upon a response being received. In some embodiments, the monitor core may determine the delay in response by subtracting a time the heartbeat was sent from a time the reply was received. In one or more of these ways, a monitor core may be enabled to determine how long it took for a target core or cores or applications, etc., to respond to a heartbeat message or whether the target failed to respond.

A status of the target to which the heartbeat message was sent may be determined based on the time delay between the heartbeat message being sent and the reply being received or based on the reply not being received. For example, if a response is received within a normal amount of time, the monitor core may determine the target is performing as expected. The normal amount of time may be a preliminary time limit, such as 0.5 seconds. A response received after the preliminary time limit may be determined to not have been received within a normal amount of time.

If a response is received but not within a preliminary time limit, the monitor core may determine the target is functioning but is not performing as expected. Such a target may be considered as being in an error state. For example, the monitor core may be enabled to wait for a maximum time limit, such as one second. After a preliminary time limit, such as 0.5 seconds, any response received—within the maximum time limit—may be considered as being received late.

If no response is received within a maximum time limit, the monitor core may be configured to determine the target is not operating and is in a crash state. For example, if the maximum time limit is one second, and if no response is received within one second, the monitor core may be configured to determine the target is not functioning.

After determining whether the target is functioning properly, functioning slowly, or not functioning at all, the monitor core may be configured to record a status in memory. Recording a status in memory may comprise recording an identifier or copy of the heartbeat message, a time the heartbeat message was sent, an indication as to the target of the heartbeat message, a response status (i.e., timely, late, or not received), and, if a response was received, an identifier or copy of the response and a time the response was received.

The status may be recorded in memory on the processor, in cache of the monitor core, in a memory device of the vehicle controller, and/or may be transmitted to another memory device onboard the vehicle itself or to a network location such as a server through a LAN or WAN connection.

At 912, the monitoring application may perform one or more functions or tasks based on the determined status.

For example, if the response to the heartbeat was received within the threshold amount of time, the monitoring application may determine the target core is performing as expected and may record the status as such in memory as a record.

It should be appreciated that even when a vehicle controller is running normally, a monitor core inside the controller can help to profile and analyze the performance of primary core and report performance profiles back to a backend server and help a company to fine tune software for even better performance.

To this effect, the monitor core may record data such as an identification of the target core, the amount of time it took for the response to be received after transmitting the heartbeat signal, and data such as program counter data, register data, cache data, memory data, etc.

If the response to the heartbeat was received outside of the threshold amount of time, the monitoring application may determine the target core is in an error state. Determining the target core is in an error state may result in the monitoring application performing functions such as saving state information indicating the error status, investigating the cause of the error status, attempting steps of triage or reparative steps, etc.

Saving state information indicating the error status may comprise saving information such as contents of cache, memory, registers, program counter, etc., of the target core, an indication of the amount of time the target core took to return the reply message in response to the heartbeat signal, etc.

Investigating the cause of the error status may comprise determining whether a program, application, process, etc., executing on the target core is consuming an excessive amount of memory, processing power, network bandwidth, etc. It should be appreciated the amount of memory, processing power, network bandwidth, etc., which is considered excessive may depend on the program, application, process, etc., and may be adjusted by user settings or by developers.

Attempt triage or performing remediation steps may comprise performing tasks such as resetting or stopping one or more applications or processes executing on the target core. For example, after investigating the cause of the error status as described herein, the monitor application may identify a culprit task as consuming an excessive amount of memory, processing power, network bandwidth, etc., and may kill or restart the culprit task. In some embodiments, triage or remediation may comprise resetting the vehicle controller itself.

If no response was received—for example after waiting a period of time in excess of the threshold amount of time—the monitoring application may determine the target core is in a fail state, has crashed, or is otherwise unresponsive.

In response to determining the target core is in a fail state or has crashed or is otherwise unresponsive, the monitor application may be configured to perform one or more functions.

Such functions may include, for example, saving data such as contents of a cache associated with the target, contents of a program counter, and/or other data associated with the target.

Such functions may include a reset of the target core, a reset of one or more applications executing on the target core or perform another type of restarting or resetting function. The monitor core may also generate a report in response to a failed target, as discussed below.

In response to detecting a crash or error or a poorly functioning target, the monitor core may be configured to stop data traffic on a network to which the target core and/or vehicle control system is connected. Stopping traffic on the network may enable the monitor core to avoid spreading the error situation or preventing the error from propagating.

For example, if the crash state of the target is due to a cyber-attack, the monitor core may be enabled to identify and respond to the cyber-attack or other network-related issue.

In some embodiments, in addition to sending heartbeat signals, the monitor core may be enabled to monitor network traffic, such as traffic over one or more of an ethernet, CAN, or LIN connection. In this way, the monitor core may be enabled to provide detection on intrusion and attack from ethernet, CAN, LIN to a vehicle controller. The monitor may be enabled to detect bandwidth being stolen or used by an unexpected task or process. In this way, the monitor can detect the system is under attack.

In some embodiments, monitoring network traffic may be performed in response to detecting an issue with a process, an application, a core, etc., through a process such as described herein.

For example, if a target core is found to be slow or unresponsive, the monitor core may be enabled to determine whether traffic associated with the target core exceeds a threshold amount of traffic or whether an amount of available bandwidth is less than a threshold amount. If an issue is found relating to the amount of bandwidth or traffic, the monitor core may be enabled to perform functions such as identifying tasks or processes consuming bandwidth, kill and/or restart culprit tasks or processes, save data relating to the traffic for inclusion in a report, and/or other functions.

For example, upon determining a target core is in a crash state or is otherwise unresponsive, the monitor application may save data associated with the target core, attempt a reset of the target core, generate a report including information associated with the state of the target core, and transmit the report to a network location.

At 915, after determining a status of one or more target cores or applications, the monitor core may be configured to generate a report. In some embodiments a method may comprise detecting an issue occurring in a core of a multi-core processor as discussed above and, in response, generating a report. In this way, a monitor application executed by a core of a multi-core processor may be configured to operate as a real-time error reporting system for reporting a status of other cores of the processor.

The monitor core may, in response to detecting the crash or error, collect data relating to the error and generate a report containing the data relating to the error.

Data to be included in the report may include contents of memory, register, cache, program counter, or other data associated with a target core or application. In some embodiments, such information may constantly be saved in memory. For example, a monitor core may be enabled to keep a running list of all such data over a past time interval (seconds, minutes, hours, etc.). For example, a tri-core microprocessor may comprise 32 registers and a program counter for a total of 33 registers. Generating a report may comprise saving a context of each of the 33 registers, application memory, and cache data.

Data in a report may include a timestamp, identification of the core or application being monitored, and other data.

Report may comprise an indication as to the determined status of the target. For example, a report may indicate whether a target responded to a heartbeat message, how long it took for the target to respond, whether the target responded within a particular time limit, an indication of a status as determined by the monitor core, e.g., responding properly, not responding, responding slowly, and/or other information.

A report may comprise data relating to a plurality of targets responding to a plurality of heartbeat messages, one target's responses to a plurality of heartbeat messages, responses of a plurality of targets to one or more heartbeat messages, or some combination thereof.

The report may be generated as a text file or other filetype and/or may be in the form of one or more data packets. A monitor core may be configured to build a long-term report, such as indicating overall health of a target, number of crashes of a target over a long period of time, etc.

In some embodiments, raw data may be transmitted to a server or other computing element which may be configured to generate a report separately from the monitor core.

At 918, the monitor core may transmit the report to a computer system such as a server over a network connection or to a separate computer system within the vehicle itself.

In some embodiments, the monitor application may be configured, after generating a report, to transmit the report upon completion or at a later time to a backend server for analysis. For example, the monitor application may be configured to detect an error, immediately collect context information about the error, take control of a network if needed, e.g., to prevent or limit damage of a cyber-attack, generate a report including the context information, and transmit the report including the error context information to a backend server over the Internet. As should be appreciated, in some embodiments, raw data may be transmitted to a server without being formed into a report.

A server, upon receiving a report, may perform a number of functions. For example, a server may use a received report to create and/or update a status log for the vehicle, the vehicle controller, the target core, or another element.

The server may also, or alternatively, use information in a report to generate a software or firmware update for the vehicle and/or other vehicles in response to an issue associated with the report. For example, based on data comprised by the report, the server may be configured to identify an issue, prepare an update to resolve the issue, and transmit the update to the vehicle from which the report originated and/or other vehicles. In this way, a whole fleet of vehicles may be updated in response to an event occurring in a single vehicle, without requiring the vehicle experiencing the issue to incur any downtime for repairs.

At 921, a determination may be made as to whether the method 900 should continue.

The determination as to whether the method 900 should continue may be based on one or more user settings. For example, the method 900 may repeat by returning to step 906 and sending an additional heartbeat. In some embodiments, and/or based on certain user settings, the method 900 may auto-continue on an interval, such as by repeating once a second or another time interval, such as once a day or once a week. The time interval for repeating the method may be based on the time the previous heartbeat signal was sent, based on the time the previous response to a heartbeat signal was received, or based on another event.

The method 900 may also not continue at 921 if, for example, the method is performed manually in response to a user command. Alternatively, or additionally, the method 900 may be performed based in response to an issue detected by another element within the vehicle. For example, another vehicle control system may detect an issue and, in response, trigger another vehicle controller to perform a method as described herein.

If the method 900 is not to continue, the method 900 may comprise proceeding to 924 at which point the method 900 may end.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/target distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a method for detecting an occurrence of an error on a multi-core processor, the method comprising: collecting data associated with a first core of a plurality of cores of a multi-core processor with an application executing on a second core of the plurality of cores; detecting, with the application executing on the second core of the plurality of cores, an occurrence of an event associated with the first core of the plurality of cores; and generating, with the application executing on the second core of the plurality of cores, a report comprising information associated with the event associated with the first core of the plurality of cores.

Aspects of the above method include the method further comprising transmitting the report via a network connection.

Aspects of the above method include wherein the report is transmitted automatically in response to the detection of the occurrence of the event.

Aspects of the above method include wherein the event is one or more of: a failure of the first core; a task consuming an amount of memory over a threshold level; a task occurring for a period of time longer than a threshold period of time; a processing consuming a percentage of CPU usage higher than a threshold percentage of CPU usage; a process consuming an amount of power in excess of a threshold amount of power; network traffic outside of a whitelist; and an application unexpectedly accesses a network connection.

Aspects of the above method include the method further comprising detecting, with the application executing on the second core, an occurrence of a second event associated with an application executing on a third core of the plurality of cores.

Aspects of the above method include wherein the event is one or more of a task taking an amount of time over a threshold amount of time, a task consuming an amount of memory over a threshold amount of memory, and a packet received by the first core from a source outside of a whitelist over a network connection.

Aspects of the above method include wherein: the event is a system crash, and the report comprises a list of all tasks and processes executing at the occurrence of the event.

Aspects of the above method include the method further comprising: determining the event is the system crash; and in response to determining the event is the system crash, transmitting the report to a network location.

Aspects of the above method include the method further comprising, in response to detecting the occurrence of the event, transmitting recovery data to the first core.

Aspects of the above method include wherein the data associated with the first core comprises runtime data associated with firmware executing on the first core.

Aspects of the above method include wherein the data associated with the first core comprises data associated with a plurality of applications executing on the first core.

Embodiments include a computer system comprising: a multi-core processor; and a computer-readable storage medium storing computer-readable instructions which, when executed by the processor, cause the processor to execute a method, the method comprising: collecting data associated with a first core of a plurality of cores of the multi-core processor with an application executing on a second core of the plurality of cores; detecting, with the application executing on the second core of the plurality of cores, an occurrence of an event associated with the first core of the plurality of cores; and generating, with the application executing on the second core of the plurality of cores, a report comprising information associated with the event associated with the first core of the plurality of cores.

Aspects of the above computer system include wherein the method further comprises transmitting the report via a network connection.

Aspects of the above computer system include wherein the report is transmitted automatically in response to the detection of the occurrence of the event.

Aspects of the above computer system include wherein the event is one or more of: a failure of the first core; a task consuming an amount of memory over a threshold level; a task occurring for a period of time longer than a threshold period of time; a processing consuming a percentage of CPU usage higher than a threshold percentage of CPU usage; a process consuming an amount of power in excess of a threshold amount of power; network traffic outside of a whitelist; and an application unexpectedly accesses a network connection.

Aspects of the above computer system include wherein the method further comprises detecting, with the application executing on the second core, an occurrence of a second event associated with an application executing on a third core of the plurality of cores.

Aspects of the above computer system include wherein the event is one or more of a task taking an amount of time over a threshold amount of time, a task consuming an amount of memory over a threshold amount of memory, and a packet received by the first core from a source outside of a whitelist over a network connection.

Aspects of the above computer system include wherein: the event is a system crash, and the report comprises a list of all tasks and processes executing at the occurrence of the event.

Aspects of the above computer system include wherein the method further comprises: determining the event is the system crash; and in response to determining the event is the system crash, transmitting the report to a network location.

Aspects include a computer program product comprising: a non-transitory computer-readable storage medium having computer-readable program code embodied therewith, the computer-readable program code configured, when executed by a multi-core processor, to execute a method, the method comprising: collecting data associated with a first core of a plurality of cores of the multi-core processor with an application executing on a second core of the plurality of cores; detecting, with the application executing on the second core of the plurality of cores, an occurrence of an event associated with the first core of the plurality of cores; and generating, with the application executing on the second core of the plurality of cores, a report comprising information associated with the event associated with the first core of the plurality of cores.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation, or technique.

The term “electric vehicle” (EV), also referred to herein as an electric drive vehicle, may use one or more electric motors or traction motors for propulsion. An electric vehicle may be powered through a collector system by electricity from off-vehicle sources or may be self-contained with a battery or generator to convert fuel to electricity. An electric vehicle generally includes a rechargeable electricity storage system (RESS) (also called Full Electric Vehicles (FEV)). Power storage methods may include chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A method for detecting an occurrence of an error on a multi-core processor, the method comprising:
collecting data associated with a first core of a plurality of cores of a multi-core processor with an application executing on a second core of the plurality of cores;
detecting, with the application executing on the second core of the plurality of cores, an occurrence of an event associated with the first core of the plurality of cores; and
generating, with the application executing on the second core of the plurality of cores, a report comprising information associated with the event associated with the first core of the plurality of cores.

2. The method of claim 1, further comprising transmitting the report via a network connection.

3. The method of claim 1, wherein the report is transmitted automatically in response to the detection of the occurrence of the event.

4. The method of claim 1, wherein the event is one or more of:
a failure of the first core;
a task consuming an amount of memory over a threshold level;
a task occurring for a period of time longer than a threshold period of time;
a processing consuming a percentage of CPU usage higher than a threshold percentage of CPU usage;
a process consuming an amount of power in excess of a threshold amount of power;
network traffic outside of a whitelist; and
an application unexpectedly accesses a network connection.

5. The method of claim 1, further comprising detecting, with the application executing on the second core, an occurrence of a second event associated with an application executing on a third core of the plurality of cores.

6. The method of claim 1, wherein the event is one or more of a task taking an amount of time over a threshold amount of time, a task consuming an amount of memory over a threshold amount of memory, and a packet received by the first core from a source outside of a whitelist over a network connection.

7. The method of claim 1, wherein:
the event is a system crash, and
the report comprises a list of all tasks and processes executing at the occurrence of the event.

8. The method of claim 7, further comprising:
determining the event is the system crash; and
in response to determining the event is the system crash, transmitting the report to a network location.

9. The method of claim 1, further comprising, in response to detecting the occurrence of the event, transmitting recovery data to the first core.

10. The method of claim 1, wherein the data associated with the first core comprises runtime data associated with firmware executing on the first core.

11. The method of claim 1, wherein the data associated with the first core comprises data associated with a plurality of applications executing on the first core.

12. A computer system comprising:
a multi-core processor; and
a computer-readable storage medium storing computer-readable instructions which, when executed by the processor, cause the processor to execute a method, the method comprising:
collecting data associated with a first core of a plurality of cores of the multi-core processor with an application executing on a second core of the plurality of cores;
detecting, with the application executing on the second core of the plurality of cores, an occurrence of an event associated with the first core of the plurality of cores; and
generating, with the application executing on the second core of the plurality of cores, a report comprising information associated with the event associated with the first core of the plurality of cores.

13. The computer system of claim 12, wherein the method further comprises transmitting the report via a network connection.

14. The computer system of claim 12, wherein the report is transmitted automatically in response to the detection of the occurrence of the event.

15. The computer system of claim 12, wherein the event is one or more of:
a failure of the first core;
a task consuming an amount of memory over a threshold level;
a task occurring for a period of time longer than a threshold period of time;
a processing consuming a percentage of CPU usage higher than a threshold percentage of CPU usage;
a process consuming an amount of power in excess of a threshold amount of power;
network traffic outside of a whitelist; and
an application unexpectedly accesses a network connection.

16. The computer system of claim 12, wherein the method further comprises detecting, with the application executing on the second core, an occurrence of a second event associated with an application executing on a third core of the plurality of cores.

17. The computer system of claim 12, wherein the event is one or more of a task taking an amount of time over a threshold amount of time, a task consuming an amount of memory over a threshold amount of memory, and a packet received by the first core from a source outside of a whitelist over a network connection.

18. The computer system of claim 12, wherein:
the event is a system crash, and
the report comprises a list of all tasks and processes executing at the occurrence of the event.

19. The computer system of claim 18, wherein the method further comprises:
determining the event is the system crash; and
in response to determining the event is the system crash, transmitting the report to a network location.

20. A computer program product comprising:
a non-transitory computer-readable storage medium having computer-readable program code embodied therewith, the computer-readable program code configured, when executed by a multi-core processor, to execute a method, the method comprising:
collecting data associated with a first core of a plurality of cores of the multi-core processor with an application executing on a second core of the plurality of cores;
detecting, with the application executing on the second core of the plurality of cores, an occurrence of an event associated with the first core of the plurality of cores; and
generating, with the application executing on the second core of the plurality of cores, a report comprising information associated with the event associated with the first core of the plurality of cores.
